(19) United States
(12) Patent Application Publication
(10) Pub. No.: US 2017/0323241 A1
(43) Pub. Date: Nov. 9, 2017

(54) METHOD AND SYSTEM FOR AUTOMATING AND INTEGRATING PROCUREMENT ACTIVITIES

(71) Applicant: GoProcure, Inc., Duluth, GA (US)

(72) Inventors: Sandeep Gauba, Berkeley Lake, GA (US); Roy R. Anderson, Dracut, MA (US); Amit Jhamvar, Atlanta, GA (US)

(73) Assignee: GoProcure, Inc., Duluth, GA (US)

(21) Appl. No.: 15/495,740

(22) Filed: Apr. 24, 2017

Related U.S. Application Data
(60) Provisional application No. 62/331,192, filed on May 3, 2016.

(51) Int. Cl. G06Q 10/06; G06Q 10/08

(52) U.S. Cl. CPC G06Q 10/06315; G06Q 10/087

(57) ABSTRACT

An automated system to receive requirements of users and present them competitive products and services for selection, authorization, order placement, supplier invoicing and payment, all through a single system. The system brings together a number of tools to deliver the functionalities required to select most appropriate products and services from a plurality of supplier databases and may also incorporate user inputs as required. The system enables cost savings, manages suppliers, reduces costs of ownership, enhances catalog management, optimizes suppliers, enhances buyer experience and obtains legally compliant agreements with suppliers.

### CROSS-REFERENCE TO RELATED APPLICATION(S)

This application claims priority to U.S. provisional application Ser. No. 62/331,192 filed on May 3, 2016, the complete disclosure of which, in its entirety, is herein incorporated by reference.

### TECHNICAL FIELD

The embodiments herein relate to methods and systems for automating and integrating procurement activities to enable a full procurement to payment cycle.

### BACKGROUND

Sourcing and procurement organizations are under pressure to continually reduce costs. Not only are they subject to volatile commodity prices and supply market risks but, like other corporate functions, they are expected to do more with less funding for their operations. At the same time, along with other parts of the supply chain, they are being tasked with delivering business value through innovative, agile, and flexible operations.

Amid these pressures, most procurement organizations understand that one place where they may be leaving money on the table and deploying their resources inefficiently is in the low-value purchases of a variety of goods in all spend categories from a large volume of suppliers, generally known as tail spend. Tail spend is often associated with purchase orders created after the fact for just record keeping and invoices generated with inadequate information on purchased items making analysis of past purchases for any kind of strategic management virtually impossible. Hence, organizations fail to realize the potential savings and deliver other, more strategic forms of business value to the larger organization.

Often times this “tail” falls outside the purview of procurement personnel with a mandate to strategically manage it and the ability to leverage the full buying power of the organization. Indeed, another way of defining tail spend is as all spend that is not strategically managed. As a result, it is often not accounted for in a company's procurement policy. Moreover, because these small purchases are not addressed by procurement personnel, they are made by employees who may not have the time or the appropriate purchasing expertise to research for the best options. This may lead to mounting waste, every day, across the enterprise. Indeed, neglecting to manage tail spend may potentially drain tens of millions of dollars annually from a company's coffers. True tail spend is the unmanaged spend that is outside of the procurement's purview and exists across the entire spend curve.

Any unmanaged spend has many other disadvantages. For example, it causes companies to be unable to use sourcing techniques for competitive bids, encourages maverick spending that is prone to fraud, results in higher transactions costs, poor buying experience and supplier dissatisfaction, prevents standardization of procurement processes across the business units, increases business risks due to lax contract coverage, makes it difficult to implement internal policies or enforce compliance to laws and lacks diversity of supplier base. For example, such spends may not comply with Sarbanes Oxley (SOX) provisions required to be followed, or may not be in accordance with diversity procurement programs such as procurement from minority, women and disadvantaged business enterprises (MWWVDBE) that the organization may have a mandate to follow.

Typical solutions such as decentralization of spend management at the business unit level, invoice automation, outsourcing to a third party etc. that are used by companies are not effective. What is needed are efficient methods and systems that enable strategic supplier solutions and optimize the benefits of strategic sourcing, procurement tools and techniques while minimizing the risk within the supply chain.

While tail spend is most prone to inefficient procurement practices as described above, all procurement activities of an organization represent opportunities for cost savings, while meeting organization objectives. At the same time, in the very fast paced business environment of today, procurement is fraught with several risks that directly impact an organization's business. A reliable supplier may go out of business tomorrow, or may raise prices unexpectedly. Likewise, a client may suddenly change/update its product specifications which may in turn require the organization to respond appropriately. Such an appropriate response may even mean a complete and quick overhaul of the supply chain. Experienced personnel may change jobs, taking their experience of procurement with them. Technologies may change, rendering one product obsolete while bringing procurement of others to the forefront, for which the organization may have no vendor base.

### SUMMARY

The embodiments herein relate to methods and systems for automating and integrating procurement activities to enable a full procurement to payment cycle.

In an aspect, the embodiments herein provide a system for automating procurement of a product from a plurality of product suppliers for an entity, the system including a non-transitory storage device having embodied therein one or more computer-processed routines operable to facilitate procurement of the product; and one or more processors coupled to the non-transitory storage device and operable to execute the one or more computer-processed routines, wherein the one or more computer-processed routines comprise: a computer product discovery engine, which when executed by the one or more processors, based on at least one attribute of the product to be procured, may automatically discover and crawl one or more public databases so as to discover the plurality of product suppliers; and a weighted factor based supplier selection module, which when executed by the one or more processors, may enable selection of at least one product supplier from the plurality of discovered product suppliers based on one or more product supplier weighted parameters.

In another aspect, the one or more public databases may be selected from any or a combination of Internet, supplier database(s) that the entity has subscription to, supplier database(s) that the entity has access to, database(s) that pertain specifically to the product, and product database(s) that are discovered by the computer product discovery engine in real-time.

In yet another aspect, the discovered public databases may be added to the list of existing supplier database(s).

In an aspect, the at least one attribute of the product may be selected from any or a combination of type of product, purpose of product, product code, and category of product. In another aspect, the one or more weighted parameters may be customizable.

In yet another aspect, the one or more weighted parameters may be selected from any or a combination of experience of the product supplier, past experience with the product supplier, ranking of the product supplier across the one or more public databases, reviews about the product supplier across one or more public databases, location of the product supplier, scale of operations of the product supplier, scope of operations of the product supplier, billing mechanism adopted by the product supplier, response time of the product supplier, level of automation incorporated by the product supplier, and cost bid proposed by the product supplier.

In an aspect, the system provided by the embodiments herein may further comprise a triage module, which when executed by the one or more processors, based on information received from the entity, may enable filtering of the discovered plurality of product suppliers.

In another aspect, the information received from the entity may be selected from information relating to any or a combination of preferred product suppliers, product suppliers used in the past, and filters to be used for shortlisting the discovered product suppliers.

In yet another aspect, the triage module may be further configured to enable bidding to be performed for procurement of the product by one or more of the discovered plurality of product suppliers. In an aspect, the product may be a service.

In another aspect, the system may further comprise a mark-up module, which when executed by the one or more processors, may enable automatic mark-up cost to be associated to the cost proposed by the selected product supplier, which marked-up cost may be used by the entity while selling the product to its consumer, and wherein the automatic mark-up cost may be computed based on any or a combination of historically applied mark-ups for the product, historically applied mark-ups for similar products, financial target to be achieved by the entity, and cost of the selected product supplier.

In an aspect, the embodiments herein provide a method for automating procurement of a product from a plurality of product suppliers for an entity, the method including the steps of: automatically discovering and crawling, using a computer product discovery engine, one or more public databases so as to discover a plurality of product suppliers based on at least one attribute of the product to be procured; and enabling selection of at least one product supplier from the plurality of discovered product suppliers based on one or more product supplier weighted parameters, using a weighted factor based supplier selection module.

In another aspect of the method, the one or more public databases may be selected from any or a combination of Internet, supplier database(s) that the entity has subscription to, supplier database(s) that the entity has access to, database(s) that pertain specifically to the product, and product database(s) that are discovered by the computer product discovery engine in real-time.

In yet another aspect of the method, the discovered public databases may be added to the list of existing supplier database(s).

In an aspect of the method, the at least one attribute of the product may be selected from any or a combination of type of product, purpose of product, product code, and category of product.

In another aspect of the method, the one or more weighted parameters may be selected from any or a combination of experience of the product supplier, past experience with the product supplier, ranking of the product supplier across the one or more public databases, reviews about the product supplier across one or more public databases, location of the product supplier, scale of operations of the product supplier, scope of operations of the product supplier, billing mechanism adopted by the product supplier, response time of the product supplier, level of automation incorporated by the product supplier, and cost bid proposed by the product supplier.

In yet another aspect, the method may further comprise using a triage module to enable filtering of the discovered plurality of product suppliers based on based on information received from the entity.

In an aspect of the method, the information received from the entity may be selected from information relating to any or a combination of preferred product suppliers, product suppliers used in the past, and filters to be used for shortlisting the discovered product suppliers.

In another aspect of the method, the triage module may be configured to enable bidding to be performed for procurement of the product by one or more of the discovered plurality of product suppliers.

In yet another aspect, the method may further comprise using a mark-up module to enable an automatic mark-up cost to be associated to the cost proposed by the selected product supplier, which marked-up cost may be used by the entity while selling the product to its consumer, and wherein the automatic mark-up cost may be computed based on any or a combination of historically applied mark-ups for the product, historically applied mark-ups for similar products, financial target to be achieved by the entity, and cost of the selected product supplier.

The embodiments herein provide an automated system that may cater to all procurement requirements of an organization in such a manner that the whole procure-to-pay cycle is tuned to delivering most effective results such as lowest cost and best quality. The system provided by the embodiments herein capture all procurement transactions and continuously grow from such transactions. Not only does the system have access to experience of in-house procurement expertise, it also is able to capitalize upon such an expertise available outside, wherever it may be globally. At anytime, the system is able to offer top management of the organization strong tools to strategically manage procurement activities.

These and other aspects, features and advantages of the embodiments herein will become apparent after a review of the following detailed description of the disclosed embodiments and the appended claims.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A shows an overall architecture diagram of the system provided by the embodiments herein showing how an entity may be offered different products, in accordance with an exemplary embodiment of the embodiments herein.

FIG. 1B shows another overall architecture of the system provided by the embodiments herein showing how an entity may access different databases in order to procure a product at terms best to it, in accordance with an exemplary embodiment of the embodiments herein.

FIG. 2 shows various modules of the system provided by the embodiments herein, in accordance with an exemplary embodiment of the embodiments herein.

FIG. 3A shows overall working of the system provided by the embodiments herein, in accordance with an exemplary embodiment of the embodiments herein.

FIG. 3B elaborates upon the system provided by the embodiments herein, in accordance with an exemplary embodiment of the embodiments herein.

FIG. 4 illustrates an overall workflow of the system provided by the embodiments herein, in accordance with an exemplary embodiment of the embodiments herein.

FIGS. 5A to 5E illustrate various operational flows of the system provided by the embodiments herein, in accordance with an exemplary embodiment of the embodiments herein.

FIG. 6 illustrates a method of the system provided by the embodiments herein, in accordance with an exemplary embodiment of the embodiments herein.

FIG. 7 illustrates an exemplary computer system in which or using which aspects of the embodiments herein may be implemented.

### DETAILED DESCRIPTION

In accordance with the embodiments herein, there is provided a system and a method for automating and integrating procurement activities in order to enable a full procure to pay cycle in most cost-effective manner, making full use of knowledge of various stake holders as well as opportunities for storing, tracking, updating and using relevant information as provided by the system provided by the embodiments herein, as elaborated hereunder using an exemplary embodiment. The embodiments herein do not limit the scope of the disclosure. The description relates purely to the exemplary embodiments and its suggested applications.

The various modules described by the examples herein and illustrated in the figures may be embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which may include a plurality of transistors and other supporting devices and circuit elements. The modules that are configured with electronic circuits process computer logic instructions that provide digital and/or analog signals for performing various functions as described herein. The various functions may be embodied and physically saved as any of data structures, data paths, data objects, data object models, object files, and database components. For example, the data objects may be configured as a digital packet of structured data. The data structures may be configured as any of an array, tuple, map, union, variant, set, graph, tree, node, and an object, which may be stored and retrieved by computer memory and may be managed by processors, compilers, and other computer hardware components. The data paths may be configured as part of a computer central processing unit (CPU) that performs operations and calculations as instructed by the computer logic instructions. The data paths may include digital electronic circuits, multipliers, registers, and buses that perform data processing operations and arithmetic operations such as Add, Subtract, etc., bitwise logical operations such as AND, OR, XOR, etc., bit shift operations such as arithmetic, logical, rotate, etc., complex operations such as using single clock calculations, sequential calculations, iterative calculations, etc. The data objects may be configured as physical locations in computer memory and may be a variable, a data structure, or a function. In the examples configured as relational databases such as Oracle® relational databases, the data objects may be configured as a table or column. Other configurations include specialized objects, distributed objects, object oriented programming objects, and semantic web objects, for example. The data object models may be configured as an application programming interface for creating HyperText Markup Language (HTML) and Extensible Markup Language (XML) electronic documents. The models may be configured as any of a tree, graph, container, list, map, queue, set, stack, and variations thereof. The data object files may be created by compilers and assemblers and contain generated binary code and data for a source file. The database components may include any of tables, indexes, views, stored procedures, and triggers.

The embodiments herein provide for an automated system to receive requirements of users (interchangeably termed as entity, client user, buyer, purchaser or requisitioner herein) and present them competitive products and services for selection, authorization, order placement, supplier invoicing and payment, all through a single system. The system brings together a number of tools to deliver the functionalities required to select most appropriate products and services from a plurality of supplier databases. The system provided by the embodiments herein enables cost savings (identifies cost savings across categories and tracks the results), manages suppliers (reduces supplier risks through allocation and optimization), reduces costs of ownership (achieves lowest total cost of ownership and tracks the results), enhances catalog management (manages catalogs, maintains technology, and builds a hierarchy), optimizes suppliers (identifies the best suppliers that meet the purchaser and stakeholder requirements), enhances buyer experience and obtains compliance (establishes legally compliant agreements with suppliers).

In an aspect, embodiments herein provide a system for automating procurement of a product from a plurality of product suppliers for an entity, the system including a non-transitory storage device having embodied therein one or more computer-processed routines operable to facilitate procurement of the product; and one or more processors coupled to the non-transitory storage device and operable to execute the one or more computer-processed routines, wherein the one or more computer-processed routines comprise: a product discovery engine, which when executed by the one or more processors, based on at least one attribute of the product to be procured, may automatically discover and crawl one or more public databases so as to discover the plurality of product suppliers; and a weighted factor based supplier selection module, which when executed by the one or more processors, may enable selection of at least one product supplier from the plurality of discovered product suppliers based on one or more product supplier weighted parameters.

In another aspect, the one or more public databases may be selected from any or a combination of Internet, supplier database(s) that the entity has subscription to, supplier database(s) that the entity has access to, database(s) that pertain specifically to the product, and product database(s) that are discovered by the computer product discovery engine in real-time.

In yet another aspect, the discovered public databases may be added to the list of existing supplier database(s).

In an aspect, the at least one attribute of the product may be selected from any or a combination of type of product, purpose of product, product code, and category of product. In another aspect, the one or more weighted parameters may be customizable.

In yet another aspect, the one or more weighted parameters may be selected from any or a combination of experience of the product supplier, past experience with the product supplier, ranking of the product supplier across the one or more public databases, reviews about the product supplier across one or more public databases, location of the product supplier, scale of operations of the product supplier, scope of operations of the product supplier, billing mechanism adopted by the product supplier, response time of the product supplier, level of automation incorporated by the product supplier, and cost bid proposed by the product supplier.

In an aspect, the system provided by the embodiments herein may further comprise a triage module, which when executed by the one or more processors, based on information received from the entity, may enable filtering of the discovered plurality of product suppliers.

In another aspect, the information received from the entity may be selected from information relating to any or a combination of preferred product suppliers, product suppliers used in the past, and filters to be used for shortlisting the discovered product suppliers.

In yet another aspect, the triage module may be further configured to enable bidding to be performed for procurement of the product by one or more of the discovered plurality of product suppliers. In an aspect, the product may be a service.

In another aspect, the system may further comprise a mark-up module, which when executed by the one or more processors, may enable automatic mark-up cost to be associated to the cost proposed by the selected product supplier, which marked-up cost may be used by the entity while selling the product to its consumer, and wherein the automatic mark-up cost may be computed based on any or a combination of historically applied mark-ups for the product, historically applied mark-ups for similar products, financial target to be achieved by the entity, and cost of the selected product supplier.

In an aspect, embodiments herein provide a computer-implemented method for automating procurement of a product from a plurality of product suppliers for an entity, the method including the steps of: automatically discovering and crawling, using a product discovery engine, one or more public databases so as to discover a plurality of product suppliers based on at least one attribute of the product to be procured; and enabling selection of at least one product supplier from the plurality of discovered product suppliers based on one or more product supplier weighted parameters, using a weighted factor based supplier selection module.

In another aspect of the method, the one or more public databases may be selected from any or a combination of Internet, supplier database(s) that the entity has subscription to, supplier database(s) that the entity has access to, database(s) that pertain specifically to the product, and product database(s) that are discovered by the computer product discovery engine in real-time.

In yet another aspect of the method, the discovered public databases may be added to the list of existing supplier database(s).

In an aspect of the method, the at least one attribute of the product may be selected from any or a combination of type of product, purpose of product, product code, and category of product.

In another aspect of the method, the one or more weighted parameters may be selected from any or a combination of experience of the product supplier, past experience with the product supplier, ranking of the product supplier across the one or more public databases, reviews about the product supplier across one or more public databases, location of the product supplier, scale of operations of the product supplier, scope of operations of the product supplier, billing mechanism adopted by the product supplier, response time of the product supplier, level of automation incorporated by the product supplier, and cost bid proposed by the product supplier.

In yet another aspect, the method may further comprise using a triage module to enable filtering of the discovered plurality of product suppliers based on based on information received from the entity.

In an aspect of the method, the information received from the entity may be selected from information relating to any or a combination of preferred product suppliers, product suppliers used in the past, and filters to be used for shortlisting the discovered product suppliers.

In another aspect of the method, the triage module may be configured to enable bidding to be performed for procurement of the product by one or more of the discovered plurality of product suppliers.

In yet another aspect, the method may further comprise using a mark-up module to enable an automatic mark-up cost to be associated to the cost proposed by the selected product supplier, which marked-up cost may be used by the entity while selling the product to its consumer, and wherein the automatic mark-up cost may be computed based on any or a combination of historically applied mark-ups for the product, historically applied mark-ups for similar products, financial target to be achieved by the entity, and cost of the selected product supplier.

These and other aspects, features and advantages of the embodiments herein will become apparent after a review of the following detailed description of the disclosed embodiments and the appended claims.

The embodiments herein and the various features and advantageous details thereof are explained with reference to the non-limiting embodiment in the following description. Descriptions of well-known components and processing techniques are omitted so as to not unnecessarily obscure the embodiments herein. The examples used herein are intended merely to facilitate an understanding of ways in which the embodiment herein may be practiced and to further enable those of skill in the art to practice the embodiment herein. Accordingly, the description should not be construed as limiting the scope of the embodiment herein.

The description hereinafter, of the specific embodiment will so fully reveal the general nature of the embodiments herein that others may, by applying current knowledge, readily modify or adapt or perform both for various applications such specific embodiment without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Although the system provided by the embodiments herein has been explained hereunder to comprise all the main components, it is completely possible that actual implementations may comprise only a part of the proposed components or a combination of those or a division of those into sub-modules in various combinations across multiple devices that may be operatively coupled with each other. All such modifications and embodiments are completely within the scope of the embodiments herein.

In an aspect, embodiments herein provide a unique technical solution to the problems encountered by various entities in making purchases and tracking important transactional details therein. In an exemplary embodiment, the embodiments herein provide solutions in the form of an automated buying desk where needs of the requisitioner (interchangeably termed as user, client user, entity, buyer or purchaser herein) are assessed and competitive products and services are presented for selection, authorization, order placement, supplier invoicing and payment. The solution brings together a number of tools to deliver the functionalities required to select most appropriate products and services from a plurality of supplier databases and is based on optimized sourcing, savings implementation, transaction management and category management.

In another aspect, the embodiments herein address the needs of processing costs, manual invoicing processes, and lack of compliance for various procurements (that may, of course, comprise but need not be limited to, tail spend which generally gets the least attention as described above) by providing a system that comprises an innovative end-to-end procurement solution packaged in at managed service provider model with a single consolidated invoice for the client. The methods and systems elaborated herein may provide lower total cost, complete invoice automation visibility into various procurements spend with approval hierarchies and audit capabilities.

In yet another aspect, the system provided by the embodiments herein may generally comprise one or more components to perform and achieve product discovery and auto creation of catalogs based upon requirements of an entity, to establish relevance and ranking amongst the plurality of product suppliers based upon weighted factors/parameters/attributes, to automatically triage and capture the entity's experience and inputs, and to provide for a mark-up logic to enable a managed service program (MSP) as elaborated hereunder. In an aspect, an exemplary object of the present system is to provide least cost and most efficient procurement in a dynamically changing internal as well as external environment.

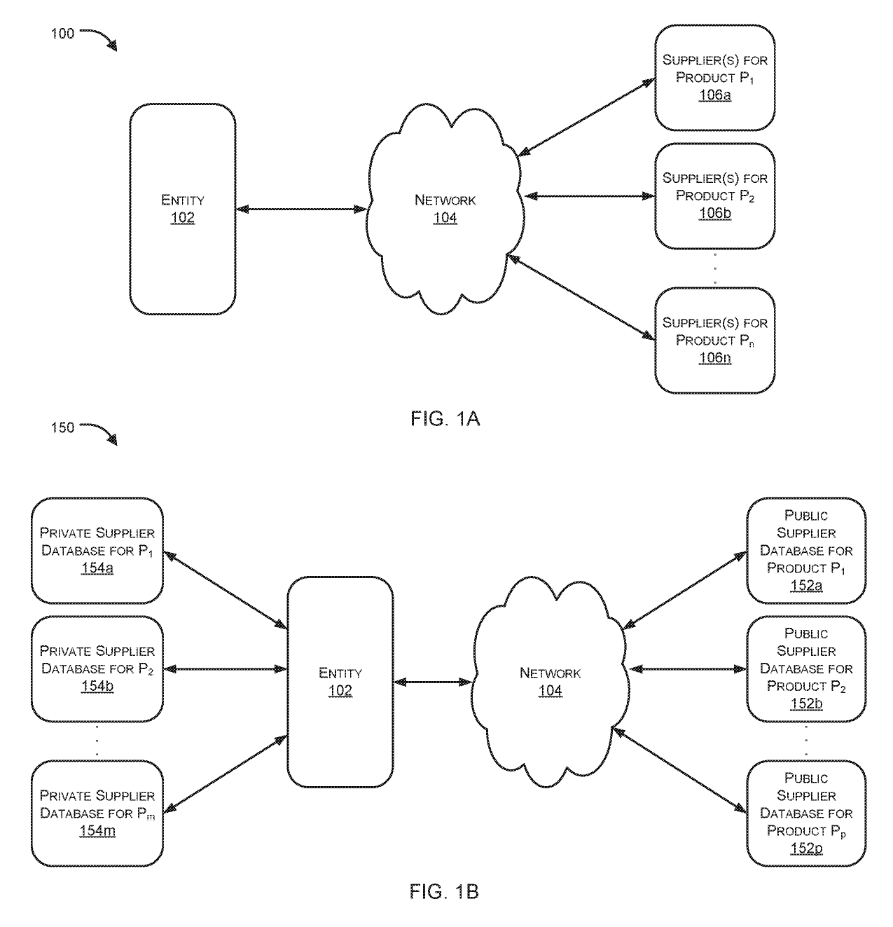

FIG. 1A shows an overall architecture diagram of a system 100 provided by the embodiments herein showing how an entity 102 may be offered different products in accordance with an exemplary embodiment of the embodiments herein. In an aspect, the system 100 provided by the embodiments herein may be configured in any or a combination of an Internet enabled device of the entity 102, mobile device of the entity 102, a website that may be accessed by the entity 102, and/or in a network/cloud that may be accessed by entity 102. The system 100 provided by the embodiments herein may also be configured such that a part of the system 100 is configured locally on computing device of the entity 102 whereas the other part is configured at the backend on the server/cloud (not shown). In an aspect, the system 100 provided by the embodiments herein may enable the entity 102 to have access to one or more potential suppliers such as 106a, 106b, . . . , and 106n for a plurality of products such as P₁, P₂, . . . , and Pₙ for its procurement needs wherein the suppliers may themselves be found in various supplier databases as elaborated with respect to the system 150 shown in FIG. 1B. With reference to FIG. 1A, it may be well appreciated that supplier(s) 106a for product P₁ need not of course be stored together, and may easily be stored across multiple databases, a few of which may be locally accessible to the entity 102 (shown as private/local supplier databases 154 in FIG. 1B) while others may be accessible over the Internet (shown as public supplier databases 152 in FIG. 1B). It is also of course possible that one database (local or remote/public) stores information of suppliers of different products, whereas another database is specialized only for storing information relating to suppliers of one product. Similarly, there could be databases that have information about one supplier selling multiple products, while others having information about multiple supplier selling multiple products. Therefore, any such database that provides information about at least one product having at least one supplier is completely within the scope of the embodiments herein. Representation of how the database presents supplier/product information is also not limited in any manner whatsoever.

In an aspect, the system 100 provided by the embodiments herein may enable an integrated procure to pay program wherein entity 102 (e.g., a user via a computing or communication device) may raise a product request consequent to which the system 100 may identify one or more relevant suppliers incorporating also, if configured, user (e.g., entity 102) inputs/experience for the same if required. The system 100 may easily transpose, capture, and absorb within itself the user's experience not only within the present organization but organizations where he/she may have worked in the past. Experience of an unstructured kind—for example, seminars that the user may have attended or even news that the user may have been exposed to, may be systematically captured by the system 100 and added to its ever-growing repository in an accessible manner not only of the particular user but of all other users of the system 100.

In an aspect, the system 100 may provide for a configurable approval workflow whereby the actions of entity 102 may be further acted upon by the system 100 only after approval that may be based upon various configurable parameters. In an exemplary embodiment, an entity's product request may require approval from his/her supervisor or a second entity before being acted upon further by the system 100. In another exemplary embodiment, the approval may be based upon a more complex logic incorporating, for example, a combination of supervisor hierarchy, category of product ordered, cost center for which the product is ordered, approval limits of the user/entity and/or supervisor etc. Such approval may also be required before the entity can issue a purchase order to a selected supplier, as elaborated further below. A plurality of approval rules may be configured and automatically deployed as per a particular requirement.

In another aspect, the system 100 may access both private (that is, within the system 100) as well as public supplier databases to search for and identify possible suppliers relevant to the product request raised by the entity 102. As further elaborated in the system 150 shown in FIG. 1B, such databases may be continuously updated automatically as well as by manual intervention and efforts of the user (and likewise, efforts of all the users of the system 100). In this manner, there are practically no restrictions on suppliers/products/services available to an entity and the entity has access to an ever-widening pool of suppliers/services.

In yet another aspect, the system 100 may automatically discover various supplier databases as formed above in line with imperatives of the organization and/or of the user. Such imperatives/parameters may be given different weights or importance factors, either automatically by the system or manually by the user to establish ranking and relevance of search results submitted to the user. Search results of possible suppliers presented to the user may accordingly be ranked in accordance with the organization's or the user's priorities.

In an aspect, the system 100 may enable the entity 102 to raise a request to a second entity to approve issuance of a purchase order to one of the suppliers selected by the system 100 as described above and, upon approval of the request, issue a purchase order to the supplier. The second entity may be one so authorized by the organization implementing the system 100 (for example, a supervisor of the user/entity 102). In this manner, the organization may exercise full control and compliance of procurement activities of entity 102. The system 100 may pass on the request received to the second entity and the approval received from the second entity to the entity/user 102 thereby enabling the user 102 to issue a purchase order to the supplier.

In an exemplary embodiment, the selected supplier may be one that has ranked the highest per weighted parameters allotted as indicated above. In another exemplary embodiment, the system 100 may automatically issue a purchase order to such a supplier, keeping the entity 102 informed. For example, for procurement below a pre-determined value, the system 100 may be so configured as to not require a purchase order issuance request and, in this case, a purchase order may directly be issued to a supplier without the intervening step of approval.

Once a purchase order has been issued either automatically by the system 100 or by the entity 102, the system 100 may track its progress to complete the procurement cycle. In exemplary embodiments, the system 100 may send reminder(s) to the supplier in line with the delivery period promised by the supplier (which may have been reconfirmed in the purchase order that is generated), may receive from the supplier dispatch details and advise the entity/user accordingly, may receive delivery acknowledgement from the entity and advise the same to the supplier, and may enable the supplier to raise an invoice once delivery is completed.

In another aspect, the system 100 may check the raised invoice(s) of the supplier for its compliance with price and other terms as settled in the purchase order. The system 100 may add a mark-up to this invoice as per its settled terms with the entity 102 (in accordance with a managed service program terms, for example) and may forward the marked-up invoice to the entity 102 for its settlement (or to the customer of the entity 102, if the managed service program so requires), delivering the product also accordingly. In an alternate exemplary embodiment, the system 100 may consolidate various invoices for different products/services procured by the entity 102 as per parameters agreed with the entity 102. Such parameters may be, for example, raising of a monthly consolidated invoice or raising a consolidated invoice when the total amount exceeds a pre-determined sum. The system 100 may accordingly receive funds from the entity 102 and in turn distribute funds to different suppliers as per individual terms such as credit terms with each supplier. The system 100 may retain the mark-up for its services before remitting funds to the supplier.

In an aspect, the system 100 may change its mark-up to reflect market conditions as well as its own experience and learning since it may capture all purchase transactions and may access them automatically as required. For example, an entity A may have procured steel bars at $100/lb, for example, in the previous transaction using the system 100 and may have now raised a request for 10 lbs of the same, under a managed service program agreement that allows the system/administrators to charge a mark-up so that final price to the entity A does not exceed $100/lb. The system 100 may bill accordingly, even though price from the vendor may have fallen as a result of a fall globally in metal prices, for example. Or, the managed service program may require the system 100 to put a mark-up not exceeding 10% of its cost price, irrespective of the last purchased price. Or, in case the marked-up price exceeds the last price billed to the entity A by 10%, the system 100 may automatically raise an escalation to senior management, who could be, for example, the manager of the supervisor of entity A, for their approval before allowing the entity A to release a purchase order. Such escalation may form part of the approval rules for issuance of a purchase order.

In this manner, it may be appreciated that the system 100 may serve as a very powerful control tool for management of various products and services being procured with checks and triggers at various points in a procurement sequence to avoid any escalation and maverick spending. The system 100 itself may continuously grow and adapt to changing market conditions incorporating an ever-increasing data of suppliers, products/services and their prices, assessments and reviews of suppliers etc. and hence become more powerful with passage of time. The system 100 may capture all transactions through it, collate them and pass them on to an automatic spend software to create “spend cubes” as elaborated further below to provide a visual representation and strategic direction to top management of organizations using the system 100. By consolidating various transactions, the system 100 may achieve economies of scale that may be used to benefit the system 100 owners and/or its constituent stakeholders.

FIG. 1B shows another overall architecture of a system 150 provided by the embodiments herein showing how an entity 102 may access different databases in order to procure products/services at terms best to it/its organization, in accordance with an example herein.

In an aspect, various suppliers for various products that may be offered to an entity 102 may themselves reside in one or more databases, wherein these databases may be private databases 154a, 154b, . . . 154m to the entity (that is, accessible only to the entity 102), or may be public databases 152a, 152b, . . . 152p. As illustrated in FIG. 1B, entity 102 may have access, via network 104 to a plurality of public supplier databases for different products. As shown, entity 102 may access public supplier database 152a for product P₁, public supplier database 152b for product P₂, . . . , and public supplier database 152p for product Pₚ. Such databases may be structured product/service databases residing in various systems (for example, a website accessible via Internet, the website operatively configured with its database) that the system 150 may either access directly using a subscription for the purpose, or from which the system 150 may extract relevant data using technologies such as bots and web crawlers to, in turn, create new databases that, in turn, may be private to itself, or may be made public by the system administrator as required. In exemplary embodiments, such databases may comprise product directories, vendor directories, phone directories etc. In alternate embodiments, entity 102 may have access to multiple public supplier databases for the same product.

In yet another aspect, the system 100, 150 may also establish tools such as bots and web crawlers to find product and supplier related information from websites that may not have structured databases and use such information as well as product/service databases for its purpose. In an exemplary embodiment, such websites may be product review sites. For example, the system 100, 150 may use information at a car sale website as a database of various car models and their prices. From a car sale website, the crawlers of the system 100, 150 may, for example, gain access to an interconnected car parts website (say, for example, a tires website) and may further use the tires website as a database of various tires. In a similar manner, the system 100, 150 may use a website of various consumer products (say TVs) as a database of such consumer products.

In an aspect, the system 100, 150 may also extract information from websites such as described above and create structured databases according to its requirements. Such structured databases may, in turn, be added to its existing list of supplier databases (interchangeably termed as catalogs) and therefore, an ever-growing range of products/services may be offered to an entity. Different hierarchical databases with parent child relationships may also be created. Databases may be subdivided into various categories or may comprise more than one category. All such combinations are fully within the scope of the embodiments herein.

In yet another aspect, entity 102 may have access to private supplier databases that may reside, for example, in a computing device that the entity 102 has direct access to, or via network 104 employing authentication mechanisms known in the art. As shown, entity 102 may access private supplier database 154a for product P₁, private supplier database 154b for product P₂, . . . , and private supplier database 154m for product Pₘ. Such private databases may be those created by the system 150 itself, incorporating information it may extract from various searches, requests for proposals, purchase orders etc. that it handles or may be those it may access via paid subscriptions, for example. In alternate embodiments, entity 102 may have access to multiple such databases for the same product. All such combinations are fully within the scope of the embodiments herein.

In an aspect, the system 100, 150 may enable entity 102 to automatically query/crawl/discover various public and private databases (after approval of request of entity 102, as described above) in accordance with its product/service request, and generate a list of possible suppliers of the same. For this purpose, the system 100, 150 may provide templates of various query forms that the entity 102 may modify as required to generate customized queries in accordance with its requirements. The system 100, 150 may provide appropriate user interfaces for these purposes and such interfaces may be provided on any computing device the entity 102 has access to. For example, the system 100, 150 may have a mobile application that may be downloaded onto a mobile phone of entity 102 to enable the entity 102 to make an appropriate query and access various databases. Entity 102 may provide in the query various supplier/product/service attributes and their weights, and may search various databases accordingly based on the assigned weights. In an exemplary embodiment, entity 102 may, for example, search for suppliers who have supplied photocopy paper to the organization over the last six months, giving highest weightage to suppliers within 10 miles of its present location, and the system 100, 150 may display, on a mobile device of entity 102, a list of such suppliers ranked accordingly. In another exemplary embodiment, entity 102 may search one or more of public databases for suppliers that have a turnover exceeding fifty million dollars, offer printing ink, and have not offered printing ink to the organization over last one year; and the system 100, 150 may display, on a mobile device of entity 102, a list of such suppliers ranked accordingly. As may be appreciated, there are many permutations and combinations for querying the various supplier databases possible that may be enabled via the system 100, 150.

In another aspect, once the system 100, 150 has generated a list of possible suppliers and sent the same to the entity 102, entity 102 may further be enabled to raise a purchase order on a selected supplier after approval of purchase order issuance request of entity 102 as described above, and the system 100, 150 may perform the full procurement to payment cycle, as described above and below. In alternate exemplary embodiments, experience and inputs of the entity 102 may be incorporated as triage to widen the potential supplier pool, as elaborated below.

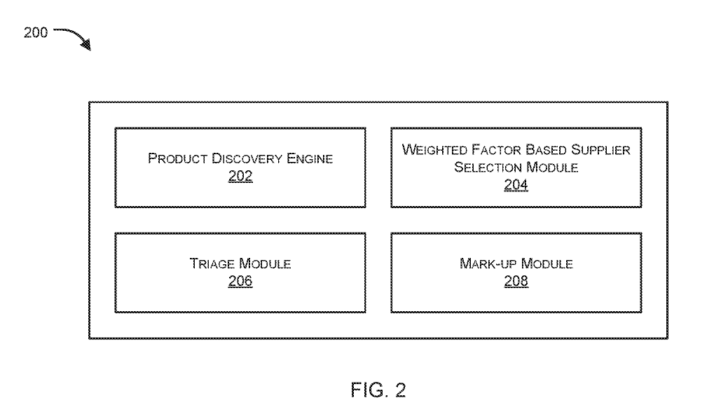

FIG. 2, with reference to FIGS. 1A and 1B, illustrates various components of a system 200 provided by the embodiments herein. In an exemplary embodiment, the system 200 may comprise four assemblies and associated components as required. These assemblies may comprise product discovery engine 202, weighted factor based supplier selection module 204, triage module 206, and mark-up module 208. These components may have the necessary means to communicate amongst one another as well as appropriate user interfaces as required to get inputs from users as well as to provide outputs in the form of actionable data to them. In an exemplary embodiment, data may be received from a user/entity 102 through an Internet enabled computing device that may be a mobile phone, wherein system 200 may have a mobile application that may be downloaded onto the mobile phone for communicating therebetween. The output of the system 200 may likewise be displayed on a user's mobile phone.

Various components as elaborated herein may be spread across multiple devices, including in the cloud, that are operatively coupled with each other. These components may be put in any sequence to achieve the desired objectives and functionalities elaborated herein and may be combined/sub-divided as required. All such modifications and embodiments are completely within the scope of the embodiments herein.

Product Discovery Engine 202

In an aspect, engine 202 may be configured with a web crawler that may, after approval of the product/service request, as described above, based on at least one attribute of the product/service (interchangeably termed as product hereinafter) to be procured, automatically discover and crawl one or more public databases by scouring one or more databases 152a, . . . 152p; 154a, . . . 154m (public or private, as shown in FIG. 1B) so as to discover a plurality of suppliers of the product and present such suppliers to an entity of the system 100, 150. Such suppliers as well as their product offerings may be added to the database(s) of the entity as well. The systems' 100, 150 own database may be a private/local database and may also be termed as its catalog, and may also be used for product discovery in addition to getting it performed on one or more public databases.

In an aspect, the system 100, 150, 200 may be configured to incorporate/use bots and web crawlers to find product and supplier related information from websites that may not have structured databases and use such information as well as product/service databases for its purpose. In yet another aspect, the system 100, 150, 200 may also extract information from websites such as these and create structured databases according to its requirements. Such structured databases may, in turn, be added to its existing list of supplier databases (interchangeably termed as catalogs) and so, an ever-growing range of products/services may be offered to an entity. Different hierarchical databases with parent-child relationships may also be created. Databases may be subdivided into various product categories or may comprise more than one product category. All such combinations are fully within the scope of the embodiments herein.

In another aspect, engine 202 may interface and communicate with other structured collections of product/service information to support discovery of more products/services and information pertaining to them. Such data may also be stored in public databases, and engine 202 may access such databases as required. In this manner, the entity 102 is not limited to only products/items that are already catalogued and from suppliers 106a, . . . 106n that are approved and contracted to supply goods but has access to an ever-widening pool of suppliers.

Engine 202 may, based on at least one attribute of the product to be procured, automatically discover and crawl one or more public databases so as to discover the plurality of product suppliers 106a, . . . 106n, wherein the at least one attribute of the product may be selected from any or a combination of a type of product, purpose of product, location of product supplier, product specification, size/shape/characteristic of the product, product code, category of product, among other attributes. Engine 202 may also select the one or more public databases from any or a combination of Internet, supplier database(s) 152a, . . . 152p that the entity has subscription to, supplier database(s) 152a, . . . 152p that the entity has access to, database(s) that pertain specifically to the product, and product database(s) that are discovered by the product discovery engine 202 in real-time. Further, engine 202 may add the discovered public databases to existing supplier/product database(s) of the system 100, 150, 200.

In this manner, while other systems limit the purchases to items that are already cataloged and from suppliers that are approved and contracted to supply the goods, the system 100, 150, 200, through its integration with product databases and other public and private databases as described above, may support product discovery by exposing over a billion products to the entity, and may extend the potential supplier base to all vendors that may be found carrying the product in a database or databases and may allow users/entities to submit requisitions for items found like this using a simple, easy-to-use interface (that may comprise a mobile interface), as elaborated further below.

In an aspect, engine 202 may enter the discovered product as a dynamic catalog entry with proper UNSPSC (United Nations Standard Products and Services Code) and category taxonomy in its own private database to form its own catalog readily accessible to all its users/entities. In this manner, data pertaining to new products and their suppliers may be added to database of engine 202. Data regarding purchases of discovered products may also be added to the system 100, 150, 200 for future purchases.

In this manner, the system 100, 150, 200 may enable a self-enhancing database of supplier network with no manual intervention that may lead both discovery of new products that may meet a buyer's requirement or discovery of similar competitive products that may be used as alternatives from within the same e-procurement system rather than via a separate (for example, a Google® search) outside the system 100, 150, 200. Such an automation of digitizing new product data in a consumable form may continuously grow the catalog(s) and supplier networks available to/in the system 100, 150, 200 and to entities using it, without any manual intervention at all.

In an aspect, system 100, 150, 200 may be configured to have, in its catalog, details of only such items that are negotiated with a client of the organization implementing the system 100, 150, 200 for a specified period of time, as required. In this case, engine 202 can be used to identify non-catalog products/items as and when they are requested and source such products/items via procedures as described above only at that time. This can enable only the latest and most accurate prices and other details for such products to be available when needed.

Weighted Factor Based Supplier Selection Module 204

In an aspect, module 204 may enable selection of at least one product supplier from the plurality of discovered product suppliers based on one or more product supplier weighted parameters, wherein the one or more weighted parameters may be customizable. In exemplary embodiments, such one or more weighted parameters may be selected from any or a combination of experience of the product supplier, past experience with the product supplier, ranking of the product supplier across the one or more public databases, reviews about the product supplier across one or more public databases, location of the product supplier, scale of operations of the product supplier, scope of operations of the product supplier, billing mechanism adopted by the product supplier, response time of the product supplier, level of automation incorporated by the product supplier, and cost bid proposed by the product supplier. In alternate exemplary embodiments, examples of weighted parameters may comprise, but are not limited to, lowest total cost, contracted supplier, diversity, level of end to end automation, supplier location, and payment mechanism.

In an exemplary embodiment, module 204 may provide a simple, easy-to-use interface (that may be a mobile interface, in some embodiments) for an entity (entity 102, for example) to query various databases and initiate a Purchase Order request in case it finds a product per its requirement and further proceed in the procurement cycle, as further elaborated below. In another aspect, if the entity 102 cannot find product that it seeks to procure, module 204 may use product category information to identify potential suppliers and may initiate Requests for Quotation (RFQs, interchangeably termed as Request for Proposals—RFPs) for such suppliers, enabling the entity 102 to provide further information as required for the RFQ/RFP to be addressed properly. For the purpose, module 204 may get triage information (as elaborated in module 206 below) in order to locate the right suppliers 106a, . . . 106n. In an alternate exemplary embodiment, triage module 206 may provide its inputs to engine 202 itself in order to facilitate triage for determination of suitable public databases itself per requirement of the entity 102.

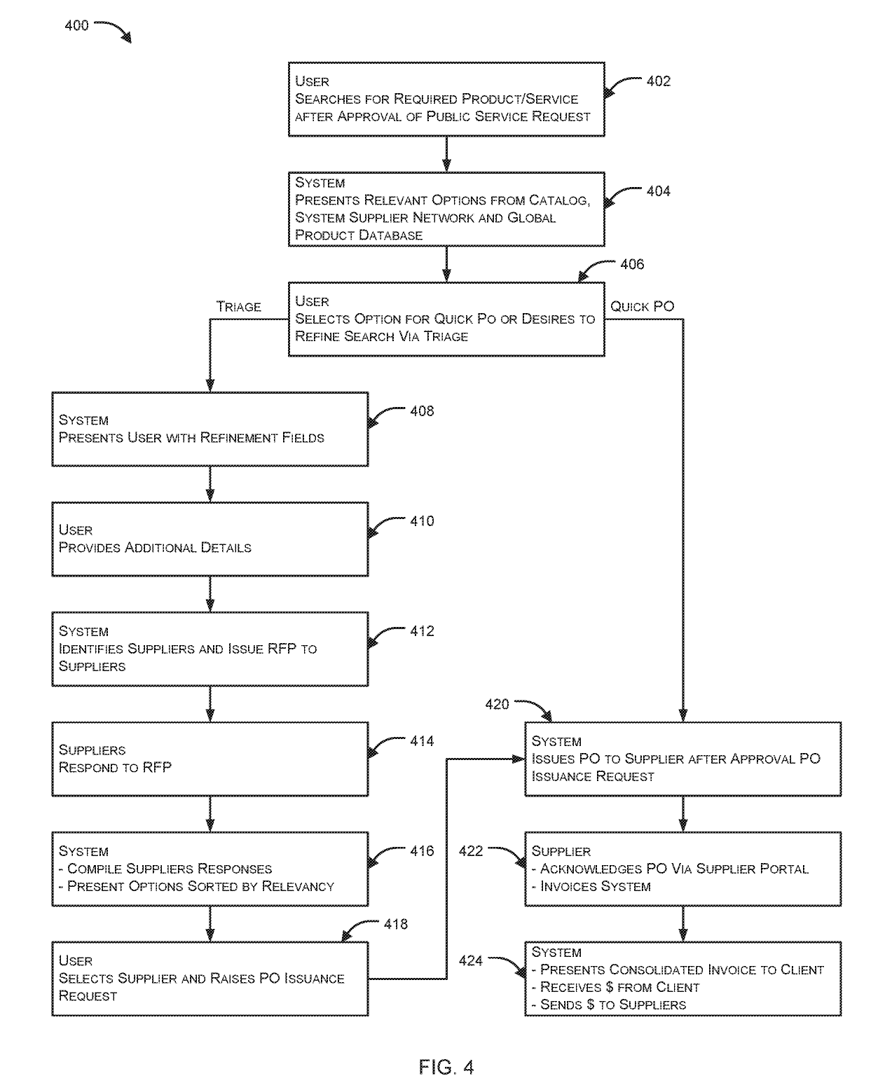

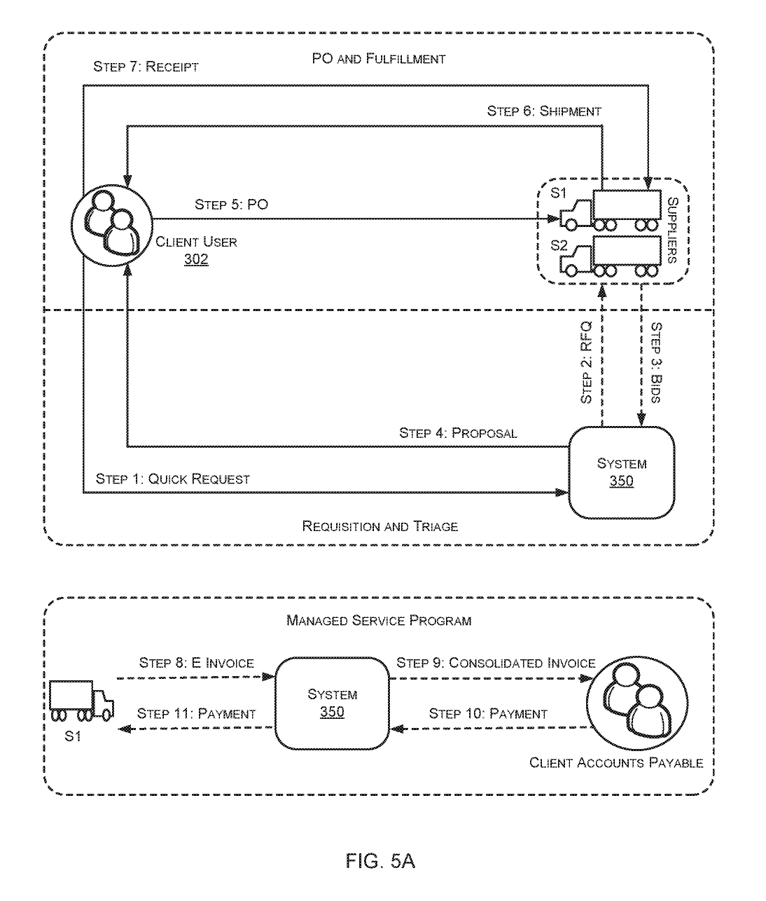

In order to complete the procurement cycle in both of the above situations, the system 100, 150, 200 may enable necessary workflows (as elaborated further with respect to FIG. 4) that may be entity/user specific and finally get an approval from the entity 102 to relevant supplier(s) 106a, . . . 106n and make a purchase. Once the user has approved a new product for purchase, all relevant data pertaining to the same such as supplier, pricing, delivery time, product attributes and specifications and any other data relevant may be added to database/catalogs accessible to engine 202 as well, for use in future triage, as elaborated further below.

In this manner, module 204 may present product search data with relevant enhanced information to an entity/requisitioner 102, presenting products in line with the entity's requirements as well as in best interests of the company of the entity 102. Module 204 may customize and weigh differently various parameters to determine the relevance of search results and thus enable the entity 102 to receive search results in accordance with its priorities/organization's priorities. In an aspect, such weights may either be pre-configured in the system 200 to enable the entity 102 to select one or more of them with corresponding values, or may be defined by the user/entity 102 in real-time during configuration of the system 200 or during execution of the module 204. In an aspect, relevance logic developed by module 204 may be applied to a mix of already cataloged products and those discovered through search for which supplier data is available in the supplier network of the system 100.

Hence, as may be appreciated, in contrast to currently available e-procurement solutions that focus on predefined contracted material within a catalog and contract structure, the embodiments herein are different and encompasses more relevant sources as the system 100, 150, 200 gathers information relevant to all available products on the Internet.

Triage Module 206

In an aspect, module 206 may enable the system 200 to ingest information known by an entity/user/client user/requisitioner/purchaser 102 (the terms being used interchangeably herein) wherein such information may comprise but is not limited to potential and/or historical supplier and categories to automate a search to locate a set of similar suppliers that may also be invited to bid for a product requirement of the entity 102. Module 206 may enhance competitive bidding of products and services in order to obtain a market based lowest total cost for the requirement with limited manual intervention by the entity/user 102. Module 206 may use information made available by the entity 102 along with the historic supplier data, the supplier network of the system 100, 150, 200, and an Internet based search to identify potential suppliers that could fulfill the entity's requirement.

In an exemplary embodiment, module 206 can identify other products, if available, that can serve the same purpose/function as the item searched and present them as possible alternatives to the entity 102. In this manner, module 206 enhances competitive bidding of products and services, leading to an overall reduction in the cost of procurement.

In yet another aspect, module 206 may, based on prior know-how and/or best/preferred practices based information received from the entity 102, filter the discovered plurality of product suppliers. The information received from the entity 102 may relate to any or a combination of preferred product suppliers, product suppliers used in the past, and filters to be used for shortlisting the discovered product suppliers. Module 206 may be further configured to enable bidding to be performed for procurement of the product by one or more of the discovered plurality of product suppliers.

In this manner, module 206 may perform triage based on information provided by the user 102 as well as that is already available with the system 100, 150, 200 and information that it may access via the Internet in order to obtain a market based lowest total cost for the requirement with limited manual intervention by the requisitioner/entity 102.

Mark-Up Module 208

In an aspect, the system 200 may further comprise mark-up module 208 that may be configured to incorporate a number of factors to create a fee structure that covers the total costs of procurement of a product, regardless of service level used for the procurement process. Such service level may be, for example, direct purchase, purchase through the RFQ, or purchase aided by sourcing process as envisaged by the system 200 (as further elaborated with respect to FIG. 4). Various other factors and their combinations may also be applied to arrive at a marked-up cost.

In another aspect, module 208 may enable an entity 102 to charge back conveniently to its customer with consolidated periodic invoices with an appropriate mark-up fee based upon the products purchased and service level used during the period, regardless of the number of suppliers used during the period, as elaborated further below.

In this manner, module 208 may enable automatic mark-up cost to be associated to the cost proposed by the selected product supplier, whereby the marked-up cost may be used by the entity 102 while selling the product to its consumer, and wherein the automatic mark-up cost may be computed based on any or a combination of historically applied mark-ups for the product, historically applied mark-ups for similar products, financial target to be achieved by the entity, and cost of the selected product supplier.

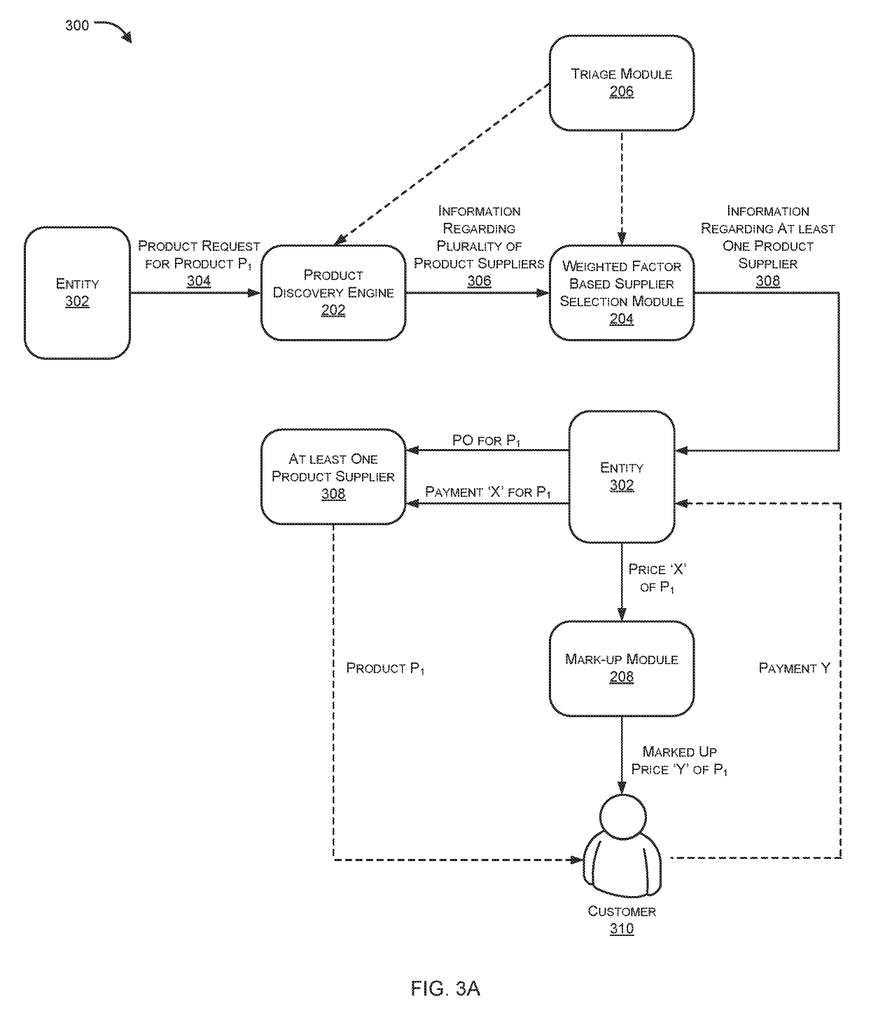

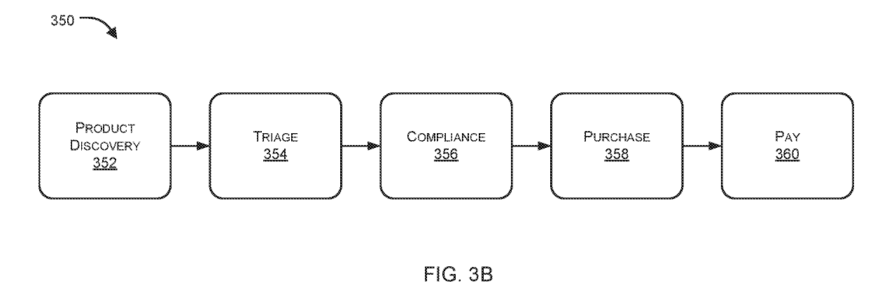

FIG. 3A, with reference to FIGS. 1A through 2, shows an overall working of a system 300 provided by the embodiments herein. As illustrated, in an exemplary embodiment, an entity/user/client user 302 desirous of purchasing an item or product P₁ may raise a product request 304 to module 202 after approval of the product request as described above. Module 202 may use various public and its own product databases (catalogs) to discover a plurality of product suppliers 306 that may cater to the product request, based upon attributes of the product P₁ and send information regarding plurality of product suppliers 306 to module 204.

In another exemplary embodiment, module 204 may be used to query these plurality of product suppliers 306 in order to select at least one product supplier 308 from them based on one or more product supplier weighted parameters, wherein the one or more weighted parameters may be customizable, and present information regarding the at least one product supplier 308 to entity 302. Module 206 may provide triage inputs to module 204 (or may also provide inputs to the product discovery engine 202) to automate a search to locate a set of similar suppliers that may also be invited to bid for a product requirement of the entity 302, if required.

In yet another exemplary embodiment, module 204 may generate information regarding the at least one product supplier 308 that may be used by entity 302 to place a purchase order (PO) for product P₁ onto the at least one product supplier 308 after approval of the purchase order issuance request as described above, for direct delivery to customer 310 of entity 302. The system 300 may next track delivery of P₁ to customer 310. Upon delivery, mark-up module 208 may enable entity 302 to provide price ‘X’ of product P₁ to itself (module 308) and may next raise an invoice on customer 310 with marked-up price ‘Y’ of P₁. The mark-up may be as per the MSP (managed service program) agreement between the customer 310 and entity 302 or their respective organizations. Next, the system 300 may enable customer 310 to pay amount ‘Y’ to entity 302 and upon receipt of this amount, entity 302 may pay amount ‘X’ to the at least one product supplier 308.

FIG. 3B, with reference to FIGS. 1A through 3A, elaborates upon various features of a system 350 provided by the embodiments herein. In an aspect, as illustrated at block 352, the system 350 enables an entity/user 302 with a simple toolset for the entity 302 to quickly search both the internal databases of the system 350 as well as other structured databases available on the Internet and thus have access to a product catalog of more than one billion and growing SKUs (stock keeping units) to find a product it requires.

In another aspect, the system 350 may be configured to take inputs from a Universal Product Code (UPC) or a QR code printed on a product/its package using appropriate readers or any other suitable image recognition device with its associated software and identify the product to be procured, and trigger the procurement process described herein.

In yet another aspect, as illustrated at block 354, the system 350 may enable triage by ingesting information known by entity 302 pertaining to contracts, competitions, diverse suppliers, automated bids etc. and also potential and/or historical suppliers 308 and categories to automate a search to locate a set of similar suppliers that may also be invited to bid for a product requirement of the entity 302.

In an aspect, as illustrated at block 356, the system 350 may ensure compliance by enabling automatic workflow, management by exception and supplier assessment. In yet another aspect, as illustrated at block 358, the system 350 may enable entity 302 to purchase the right product from the right supplier 308 at the right price. The system 350 may provide data generated from each such purchase transaction to an automated spend analysis software that may, in turn, generate a spend cube to enable a visual representation of all purchasing activities wherein the three dimensions represent Suppliers, Corporate business units, and Category of items and the contents of the cube hold prices and volumes of items purchased. In this manner, the system 350 may help management such as Chief Financial Officers and Chief Purchasing Officers, etc. gain insight into what their company buys and from whom, and help the organization realize savings promised by past sourcing efforts.

In yet another aspect, as illustrated at block 360, the system 350 may enable centralized cash management in a flexible and secure manner. The system 350 may integrate with a variety of payment methods such as credit/debit cards for individual transactions as well as Automated Clearing Houses (ACH) wherein large volumes of transactions are to be cleared in batches.

FIG. 4, with reference to FIGS. 1A through 3B, illustrates an overall method 400 provided by the embodiments herein for tail spend management (TSM). In an aspect, as illustrated at block 402, the system 300 may enable a user user/entity 302 to search for a required item/product/service after approval of the product/service request, as described above. In an exemplary embodiment, such product may belong to “tail spend” as described above and may/may not have prior procurement history. At block 404, the system 300 may present various relevant options to the user/entity 302. Such options may be presented from a variety of sources such as a private supplier database of the entity (its own catalog), the system's supplier network, or global product databases that the system 300 may access on ongoing basis. At block 406, the system 300 may enable the user 302, upon seeing the options, to either choose to generate a quick purchase order, or choose to further refine search for suitable vendors via triage.

In another aspect, in case the user 302 chooses to employ triage, at block 408, the system 350 may present the user 302 with refinement fields (as described above under module 206 elaborating triage) upon using which the user 302 may provide additional details, as illustrated at block 410. At block 412, upon receipt of such additional details, the system 350 may automatically identify a set of possible suppliers and issue RFPs (request for proposals) to those suppliers and as shown at block 414, and the suppliers may respond to the RFPs. At block 416, the system 350 may receive and compile such responses appropriately and present various options sorted by relevancy to the user 302, from which the user 302 may select a supplier as shown at block 418 and raise a purchase order issuance request.

In yet another aspect, at block 420, after approval of the purchase order issuance request, the system 350 may issue a purchase order to a selected supplier 308. As shown at block 422, the system 350 may enable the supplier 308 to acknowledge the order. In an exemplary embodiment, the system 350 may have an integrated supplier portal to enable acknowledgement of the purchase order. Consequently, the supplier 308 may deliver ordered product/service to the user/entity 302 and, after receiving receipt acknowledgement, raise an invoice on the system 350 that the system 350 may receive. As illustrated at block 424, the system 350 may, in a similar manner, receive invoices for a plurality of products/services being supplied to the user 302 and as per pre-determined parameters raise a consolidated invoice and present the same to the client/user 302. Finally, as shown at block 424, the system 350 may receive funds from the user 302 and in turn, distribute funds received to various suppliers 308 as per terms agreed with them.

In another aspect, if the user 302 chooses to generate a quick purchase order, he/she may immediately raise a purchase order issuance request and the system 350 may directly proceed to block 420 and issue a purchase order to a supplier 308, after approval of the purchase order issuance request. In an exemplary embodiment, the system 350 may automatically select this supplier based upon a match of the requirement of user 302 of product, quantity, price, delivery and other terms to various supplier data it already has or may generate automatically, to achieve most efficient procurement for the entity 302. Next, blocks 422 and 424 may follow to perform similar functions as described above whereby a supplier 308 may acknowledge the purchase order via a supplier portal and receive/pay an invoice through the system 350, and the system 350 may present a consolidated invoice to a client/customer 310, receive payment from the client/customer 310, and send money/payments to suppliers 308.

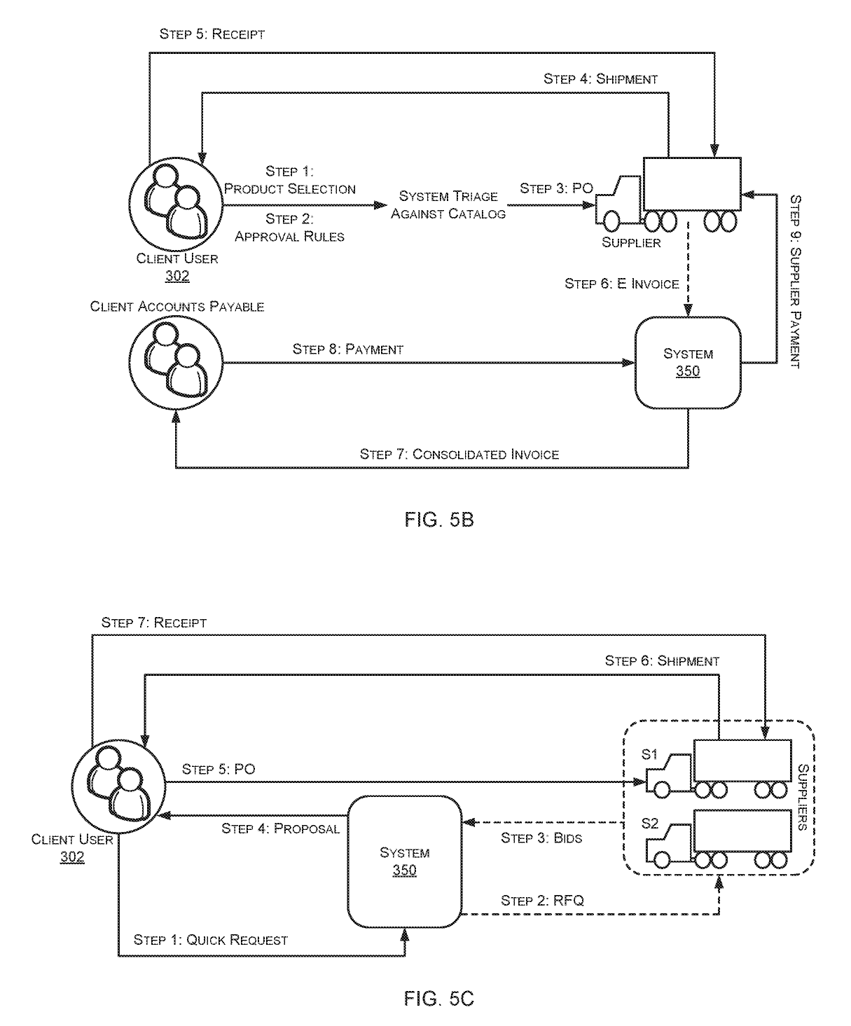

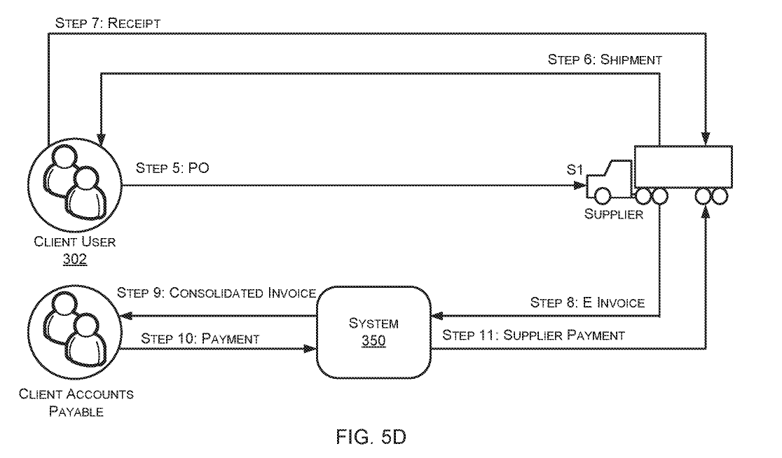

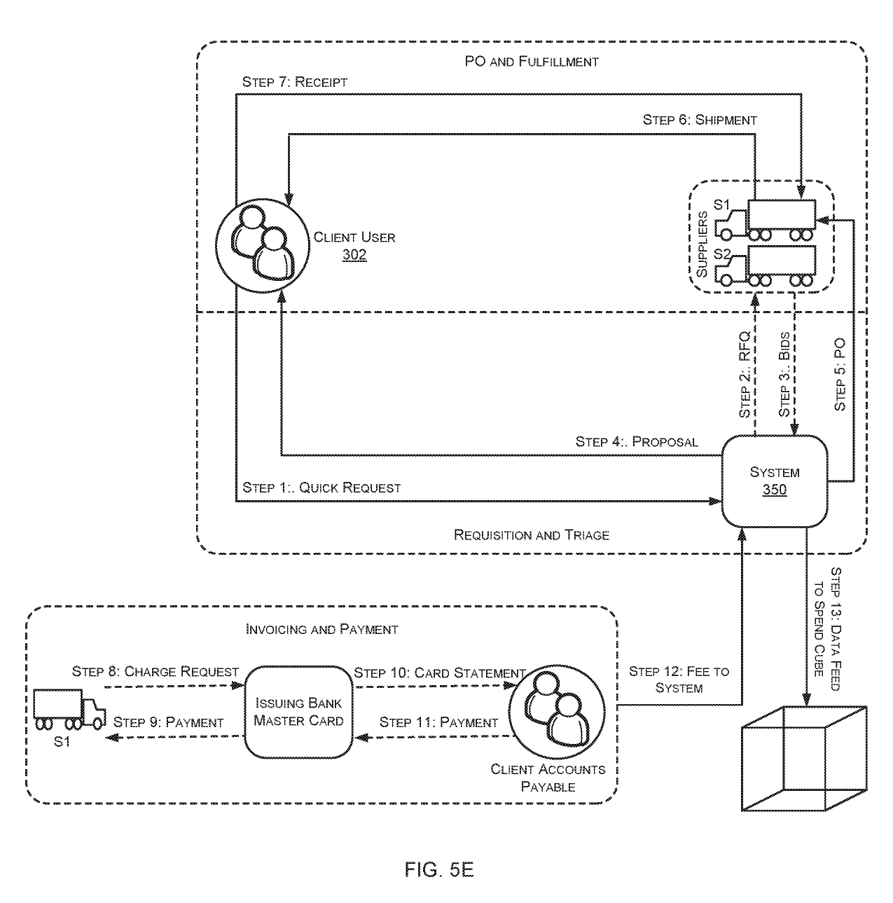

FIGS. 5A to 5E, with reference to FIGS. 1A through 4, illustrate various operational flows in accordance with an exemplary embodiment herein.

In FIG. 5A, as illustrated at Step 1, a client user 302 (interchangeably termed as entity or user 302 herein) desirous of purchasing an item/product may raise a quick request to the system 350, after approval of the product request. The quick request may carry various user inputs such as item description, quantity, photograph, and suggested supplier as well as default information such as cost center to which the product cost is to be allocated, delivery location, category of product etc.

In another aspect, as illustrated at Step 2, the system 350 may, based on details provided in Step 1, identify suitable suppliers 308 and send them a RFQ (request for quotation) based on which the suppliers 308 may revert with different bids as shown at Step 3. In exemplary embodiments, each supplier 308 may be enabled to provide different data such as supplier name, address, DUNS#, tax ID, bank details, product/service description, unit of measure and unit price in its bid.

In yet another aspect, the system 350 may determine the most suitable bid from the bids received and may send proposal detailing the same to the user 302 as illustrated at Step 4. The system 350 may also enable triage if required. The proposal may carry information as provided in the supplier's bid. In alternate exemplary embodiments, the system 350 may send a plurality of proposals; e.g., the top three proposals, for the user 302 to select one. At Step 5, the user 302 may accept the proposal and may raise a purchase order issuance request, after approval of which he/she may send a purchase order (PO) accordingly to the selected supplier S1 as shown.

In an exemplary embodiment, the purchase order may carry an input of approval (for example, a stamp “Approved” may be automatically put on the purchase order generated, along with digital signatures of the approving entity in order to help in authentication of the purchase order, if and when required) as well as other information such as purchase order number, cost center, general ledger, quantity, supplier reference number, price on purchase order, etc.

In an aspect, as illustrated at Step 6, a selected supplier S1 may ship a product per the purchase order to the user 302 and at Step 7, and the user 302 may confirm receipt to the supplier S1. The system 350 may keep track of these steps of purchase order generation, shipment by supplier 308, and receipt by the user 302.

In yet another aspect, as shown at Step 8, supplier S1 may raise an e-invoice. In an exemplary embodiment, the e-invoice may carry supplier input; namely, the total amount due, line items, tax, and shipment details, etc. It may also carry other information such as purchase order number. In an MSP (Managed Service Program) model being elaborated herein, supplier S1 may send the invoice to the system 350 herein and likewise, the system 350 may receive a plurality of invoices for various products from one or more suppliers 308. At a pre-determined parameter (for example, time elapsed or total amount due), the system 350 may prepare a consolidated invoice and send the consolidated invoice to the AP (accounts payable) department of the user 302, as shown at Step 9. In an exemplary embodiment, the consolidated invoice may carry information such as line items, total amount, line item (purchase orders) amounts, and line item cost centers, etc.

In an aspect, as shown at Step 10, the AP department of user 302 may remit payment to the system 350 and the system 350 may, in turn, as shown at Step 11, remit payment to the supplier(s) S1, S2 as appropriate.

FIG. 5B illustrates an operational flow for catalog orders using the system 350, in accordance with an exemplary embodiment herein. In an aspect, the system 350 may handle purchase of products already in its databases/catalog. As illustrated at Steps 1 and 2 in FIG. 5B, an entity (client user 302, for example) may send product selection (product request) along with approval rules (such approval rules indicating, for example, how and from whom the product request has to be approved) to the system 350. The product selection and approval rules may be in the form of a quick requisition that may carry user 302 inputs such as item selection, quantity and approval rules; and defaulted information such as cost center, delivery location, category, supplier, unit price and unit of measure (UOM). The system 350 may accordingly get approval of the product request and, after such approval, perform triage against its catalog; i.e., it may check which products match the product attributes as provided by the user 302. Upon finding a match, the system 350 may raise a purchase order issuance request and upon its approval (such approval may be based upon approval rules already specified), send a purchase order to a corresponding supplier, as illustrated at Step 3. The purchase order may carry information such as purchase order number, cost center, general ledger, quantity, supplier reference number and unit price, etc.

In another aspect, upon receipt of a purchase order, a selected supplier may ship the ordered product(s) to the user 302, as shown at Step 4 and the user 302 may, as shown at Step 5, confirm receipt of the product(s) to the supplier. The system 350 may keep track of the shipment as well as receipt. Once user 302 has confirmed receipt, the supplier 308 may, as indicated at Step 6, raise an e-invoice and send the same to the system 350. As described above, the system 350 may raise a consolidated invoice and send it to account payable department of user 302 (Step 7), receive payment of the consolidated invoice (Step 8), and thereupon make supplier payment (Step 9).

In yet another aspect, the system 350 may provide data generated from each purchase transaction to an automated spend analysis software that may in turn generate a spend cube to enable a visual representation of all purchasing activities, as described above with reference to FIG. 3B.

FIG. 5C illustrates an operational flow for non-catalog orders using the system 350, in accordance with an exemplary embodiment herein. In an aspect, as illustrated at Step 1, an entity/client user 302 desirous of purchasing an item/product may raise a quick request to the system 350. The quick request may carry various user inputs such as item description, quantity, photograph and suggested supplier as well as information such as cost center to which the product cost is to be allocated, delivery location, category of product, etc., along with its approval rules based upon which the system 350 may accordingly get approval of the product request.

In another aspect, as illustrated at Step 2, the system 350 may, based on details provided in Step 1, identify suitable suppliers and send them a RFQ. The suppliers 308 may revert with different bids, as shown at Step 3. In exemplary embodiments, each supplier 308 may be enabled to provide different data such as supplier name, address, DUNS#, tax ID, bank details, product/service description, unit of measure and unit price, etc. in its bid.

In yet another aspect, the system 350 may determine the most suitable bid from the bids received and may send a proposal detailing the same to the user 302, as illustrated at Step 4. If required, the system 350 may enable triage by the user 302. The proposal may carry information as provided in the supplier's bid. In alternate exemplary embodiments, the system 350 may send a plurality of proposals; e.g., the top three proposals, for the entity/user 302 to select one. At Step 5, the user 302 may accept the proposal and may raise a purchase order issuance request and, upon its approval, send a purchase order accordingly to the selected supplier S1 as shown. In an exemplary embodiment, the purchase order may carry the input of approval as well as information such as purchase order number, cost center, general ledger, quantity, supplier reference number, price on purchase order, etc.

In an aspect, as illustrated at Step 6, a selected supplier S1 may ship the product per purchase order to the user 302 and at Step 7, user 302 may confirm receipt to the supplier S1. The system 350 may keep track of these steps of purchase order generation, shipment by supplier, and receipt by the user 302.

FIG. 5D illustrates an operational flow for invoicing and payment using the system 350, in accordance with an exemplary embodiment herein. In an aspect, as illustrated at Step 5, an entity/client user 302 may raise a PO onto a supplier S1, for example, based upon which the supplier S1 may make a shipment of required product, as shown at Step 6. Upon receipt of the product, the client user 302 may send an acknowledgement of receipt, as shown at Step 7.

In another aspect, as shown at Step 8, the supplier S1 may raise an e-invoice after receiving acknowledgement of receipt from the entity/client user 302. In an exemplary embodiment, the e-invoice may carry supplier input; namely, the total amount, line items, tax and shipment details. It may also carry information such as purchase order number, etc. Likewise, the system 350 may receive a plurality of invoices from various products from one or more suppliers 308. At a pre-determined parameter (for example, time elapsed or total amount due), the system 350 may prepare a consolidated invoice and send the consolidated invoice to the AP (accounts payable) department of the user 302, as shown at Step 9. In an exemplary embodiment, the consolidated invoice may carry information such as line items, total amount, line item (purchase orders) amounts, and line item cost centers, etc.

In yet another aspect, as shown at Step 10, the AP department of user 302 may remit payment to the system 350 and the system 350 may, in turn, as shown at Step 11, remit payment to the supplier(s) S1 as appropriate.

In another aspect, the system 350 may provide data generated from each purchase transaction to an automated spend analysis software that may in turn generate a spend cube to enable a visual representation of all purchasing activities, as described above with reference to FIG. 3B.

FIG. 5E illustrates another operational flow of the system 350, wherein the system 350 automatically issues purchase orders and employs a banking solution such as a credit card, in accordance with an exemplary embodiment herein. In an aspect, as illustrated at Step 1, an entity/client/user 302 desirous of purchasing an item/product may raise a quick request to the system 350. The quick request may carry various user inputs such as item description, quantity, photograph/UPC/QR code and suggested supplier as well as information such as cost center to which the product cost is to be allocated, delivery location, category of product, etc., along with its approval rules based upon which the system 350 may accordingly get approval of the product request.

In another aspect, as illustrated at Step 2, the system 350 may, based on details provided in Step 1, identify suitable suppliers and send them a RFQ. The suppliers S1, S2 may revert with different bids, as shown at Step 3. In exemplary embodiments, each supplier S1, S2 may be enabled to provide different data such as its preferred product (that may be, for example, readily available in stock or lowest priced etc. while being closest to the request), supplier name, address, DUNS#, tax ID, bank details, and proposed pricing in its bid.

In yet another aspect, the system 350 may determine the most suitable bid from the bids and may send a proposal detailing the same to the user 302, as illustrated at Step 4. The system 350 may enable triage (as described above with respect to module 206 in FIG. 2) if required. The proposal may carry information as provided in the supplier's bid such as product/service description, UOM (unit of measure), unit price and delivery date, etc.

At the same time, the system 350 may automatically raise a purchase order issuance request and, upon its approval, send a purchase order

to the supplier S1 of the most suitable bid, as illustrated at Step 5. In an exemplary embodiment, the purchase order may carry user 302 input such as charge authorization as well as information such as purchase order number, cost center, general ledger, quantity, supplier reference number, price on purchase order, etc.

In an aspect, as illustrated at Step 6, a selected supplier S1 may ship the product per purchase order to the user 302 and at Step 7, the user 302 may acknowledge receipt to the supplier S1. The system 350 may keep track of these Steps of purchase order generation, shipment by supplier, and receipt by the user 302.

In another aspect, once the supplier S1 has received acknowledgement of receipt from the user 302, supplier S1 may raise a charge request to an issuing bank or credit card issuer, as illustrated at Step 8. The charge request may carry the supplier's input of the total amount payable to him/her. The issuing bank may pay the supplier S1 as illustrated at Step 9. As per terms of the issuing bank with the user 302, the issuing bank may prepare a card statement and send it to the Accounts Payable (AP) department of the user 302, as shown at Step 10. The card statement may carry the total amount as well as its breakup showing supplier details and amounts payable to each supplier 308. The AP department may accordingly pay the issuing bank, as illustrated at Step 11. Consequently, the issuing bank may pay any fees due to the system 350, as illustrated at Step 12.

In yet another aspect, as illustrated at Step 13, the system 350 may provide data generated from each purchase transaction to an automated spend analysis software that may, in turn, generate a spend cube to enable a visual representation of all purchasing activities, as described above with reference to FIG. 3B.

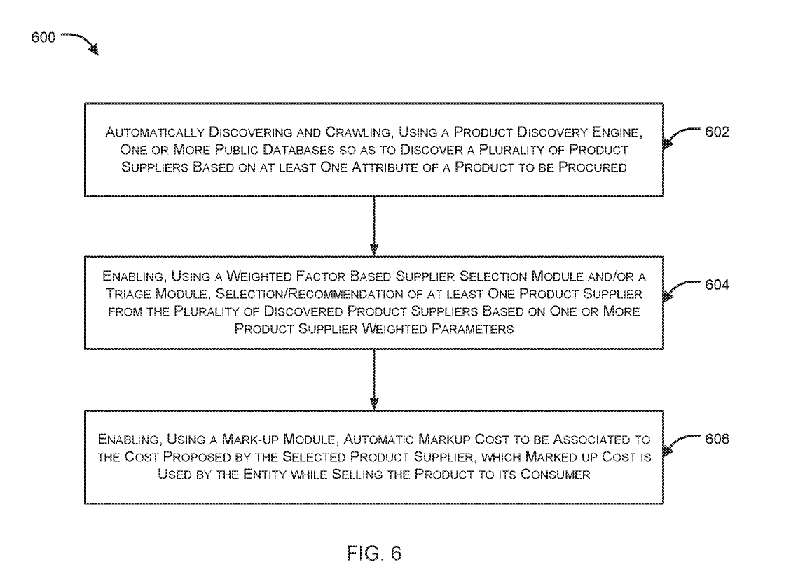

FIG. 6, with reference to FIGS. 1A through 5E, illustrates a computer-implemented method 600, in accordance with an exemplary embodiment herein. In an aspect, the method 600 may comprise, at block 602, automatically discovering and crawling, using a computer product discovery engine, one or more public databases so as to discover a plurality of product suppliers 308 based on at least one attribute of a product to be procured. At block 604, the method 600 may comprise enabling, using a weighted factor based supplier selection module and/or a triage module, selection/recommendation of at least one product supplier from the plurality of discovered product suppliers 308 based on one or more product supplier weighted parameters. The method 600, at block 606, may comprise enabling, using a mark-up module, automatic mark-up cost to be associated to the cost proposed by the selected product supplier, which marked-up cost is used by the entity while selling the product to its consumer.

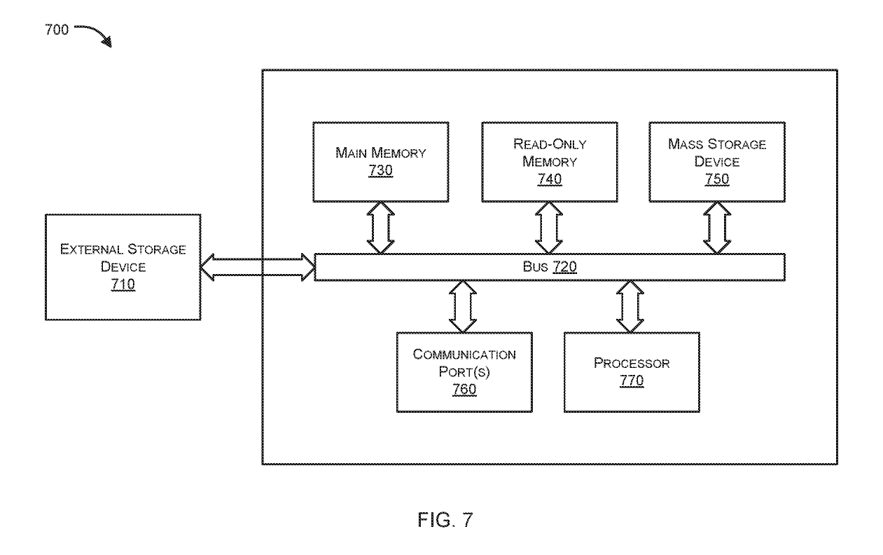

FIG. 7, with reference to FIGS. 1A through 6, illustrates an exemplary computer system 700 in which or using which aspects of the embodiments herein may be implemented. The embodiments herein comprise various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 700 comprises a bus 720, a processor 770, communication port 760, a main memory 730, a removable storage media 710, a read only memory 740 and a mass storage 750. Computer system 700 may comprise more than one processor and communication ports. Examples of processor 770 comprise, but are not limited to, an Intel® Itanium® or Itanium® 2 processor(s), or AMD® Opteron® or Athlon MP® processor(s), Motorola® lines of processors, FortiSOC™ system on a chip processors or other processors. Processor 770 may comprise various modules associated with embodiments of the embodiments herein. Communication port 760 may be any of an RS-232 port for use with a modem based dialup connection, a 10/100 Ethernet port, a Gigabit or 10 Gigabit port using copper or fiber, a serial port, a parallel port, or other existing or other ports. Communication port 760 may be chosen depending on a network, such a Local Area Network (LAN), Wide Area Network (WAN), or any network to which computer system 700 connects. Memory 730 may be Random Access Memory (RAM), or any other dynamic storage device commonly used. Read only memory 740 may be any static storage device(s); e.g., but not limited to, a Programmable Read Only Memory (PROM) chips for storing static information; e.g. start-up or BIOS instructions for processor 770. Mass storage 750 may be any type of mass storage solution, which may be used to store information and/or instructions. Exemplary mass storage solutions comprise, but are not limited to, Parallel Advanced Technology Attachment (PATA) or Serial Advanced Technology Attachment (SATA) hard disk drives or solid-state drives (internal or external; e.g., having Universal Serial Bus (USB) and/or Firewire interfaces), and one or more optical discs, Redundant Array of Independent Disks (RAID) storage; e.g. an array of disks (e.g., SATA arrays). Bus 720 communicatively couples processor(s) 770 with the other memory, storage and communication blocks. Bus 720 may be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to a software system. Optionally, wire operator and administrative interfaces; e.g. a display, keyboard, and a cursor control device, may also be coupled to bus 720 to support direct operator interaction with computer system 700. Other operator and administrative interfaces may be provided through network connections connected through communication port 760. External storage device 710 may be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system 700 limit the scope of the embodiments herein.

The terminology used herein is for the purpose of describing particular example embodiments only and is not intended to be limiting. As used herein, the singular forms “a”, “an” and “the” may be intended to comprise the plural forms as well, unless the context clearly indicates otherwise.

The terms “comprises,” “comprising,” “including,” and “having,” are inclusive and therefore specify the presence of stated features, integers, steps, operations, elements, or components, but do not preclude the presence or addition of one or more other features, integers, steps, operations, elements, components, or groups thereof. The method steps, processes, and operations described herein are not to be construed as necessarily requiring their performance in the particular order discussed or illustrated, unless specifically identified as an order of performance. It is also to be understood that additional or alternative steps may be employed.

The use of the expression “at least” or “at least one” suggests the use of one or more elements, as the use may be in one of the embodiments to achieve one or more of the desired objects or results.

The process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for automating procurement of a product from a plurality of product suppliers for an entity, the system comprising:
a non-transitory storage device having embodied therein one or more computer-processed routines operable to facilitate procurement of the product; and
one or more processors coupled to the non-transitory storage device and operable to execute the one or more computer-processed routines, wherein the one or more computer-processed routines comprise:
a computer product discovery engine, which when executed by the one or more processors, based on at least one attribute of the product to be procured, automatically discovers and crawls one or more public databases so as to discover the plurality of product suppliers; and
a weighted factor based supplier selection module, which when executed by the one or more processors, enables selection of at least one product supplier from the plurality of discovered product suppliers based on one or more product supplier weighted parameters.

2. The system of claim 1, wherein the one or more public databases are selected from any or a combination of Internet, supplier database(s) that the entity has subscription to, supplier database(s) that the entity has access to, database(s) that pertain specifically to the product, and product database(s) that are discovered by the computer product discovery engine in real-time.

3. The system of claim 1, wherein the discovered public databases are added to the list of existing supplier database(s).

4. The system of claim 1, wherein the at least one attribute of the product is selected from any or a combination of type of product, purpose of product, product code, and category of product.

5. The system of claim 1, wherein the one or more weighted parameters are customizable.

6. The system of claim 1, wherein the one or more weighted parameters are selected from any or a combination of experience of the product supplier, past experience with the product supplier, ranking of the product supplier across the one or more public databases, reviews about the product supplier across one or more public databases, location of the product supplier, scale of operations of the product supplier, scope of operations of the product supplier, billing mechanism adopted by the product supplier, response time of the product supplier, level of automation incorporated by the product supplier, and cost bid proposed by the product supplier.

7. The system of claim 1, further comprising a triage module, which when executed by the one or more processors, based on information received from the entity, enables filtering of the discovered plurality of product suppliers.

8. The system of claim 7, wherein the information received from the entity is selected from information relating to any or a combination of preferred product suppliers, product suppliers used in the past, and filters to be used for shortlisting the discovered product suppliers.

9. The system of claim 7, wherein the triage module is further configured to enable bidding to be performed for procurement of the product by one or more of the discovered plurality of product suppliers.

10. The system of claim 1, further comprising a mark-up module, which when executed by the one or more processors, enables automatic mark-up cost to be associated to the cost proposed by the selected product supplier, which marked-up cost is used by the entity while selling the product to its consumer.

11. The system of claim 10, wherein the automatic mark-up cost is computed based on any or a combination of historically applied mark-ups for the product, historically applied mark-ups for similar products, financial target to be achieved by the entity, and cost of the selected product supplier.

12. A computer-implemented method for automating procurement of a product from a plurality of product suppliers for an entity, the method comprising:
automatically discovering and crawling, using a computer product discovery engine, one or more public databases so as to discover a plurality of product suppliers based on at least one attribute of the product to be procured; and
enabling selection of at least one product supplier from the plurality of discovered product suppliers based on one or more product supplier weighted parameters, using a weighted factor based supplier selection module.

13. The method of claim 12, wherein the one or more public databases are selected from any or a combination of the Internet, supplier database(s) that the entity has subscription to, supplier database(s) that the entity has access to, database(s) that pertain specifically to the product, and product database(s) that are discovered by the computer product discovery engine in real-time.

14. The method of claim 12, wherein the discovered public databases are added to the list of existing supplier database(s).

15. The method of claim 12, wherein the at least one attribute of the product is selected from any or a combination of type of product, purpose of product, product code, and category of product.

16. The method of claim 12, wherein the one or more weighted parameters are selected from any or a combination of experience of the product supplier, past experience with the product supplier, ranking of the product supplier across the one or more public databases, reviews about the product supplier across one or more public databases, location of the product supplier, scale of operations of the product supplier, scope of operations of the product supplier, billing mechanism adopted by the product supplier, response time of the product supplier, level of automation incorporated by the product supplier, and cost bid proposed by the product supplier.

17. The method of claim 12, further comprising using a triage module to enable filtering of the discovered plurality of product suppliers based on based on information received from the entity.

18. The method of claim 17, wherein the information received from the entity is selected from information relating to any or a combination of preferred product suppliers, product suppliers used in the past, and filters to be used for shortlisting the discovered product suppliers.

19. The method of claim 17, wherein the triage module is further configured to enable bidding to be performed for procurement of the product by one or more of the discovered plurality of product suppliers.

20. The method of claim 12, further comprising using a mark-up module to enable an automatic mark-up cost to be associated to the cost proposed by the selected product supplier, which marked-up cost is used by the entity while selling the product to its consumer, and wherein the automatic mark-up cost is computed based on any or a combination of historically applied mark-ups for the product, historically applied mark-ups for similar products, financial target to be achieved by the entity, and cost of the selected product supplier.
